(19) United States
(12) Patent Application Publication
(10) Pub. No.: US 2007/0061210 A1
(43) Pub. Date: Mar. 15, 2007

(54) Methods for reducing retail out-of-stocks using store-level RFID data

(76) Inventors: Li Chen, Jersey City, NJ (US); Jie Weng, Sunnyvale, CA (US); Raymond Blanchard, Morgan Hill, CA (US); Baskar Jayaraman, Fremont, CA (US); Eric Peters, Aptos, CA (US); Suresh Kuppahally, Saratoga, CA (US); Calvin B. Lee, San Francisco, CA (US)

Correspondence Address: FISH & RICHARDSON P.C., PO BOX 1022, MINNEAPOLIS, MN, 55440-1022, US

(21) Appl. No.: 11/519,449

(22) Filed: Sep. 11, 2006

Related U.S. Application Data
(60) Provisional application No. 60/715,778, filed on Sep. 9, 2005.

(51) Int. Cl. G06Q 90/00

(52) U.S. Cl. 705/22

(57) ABSTRACT

Methods and systems for predicting out-of-stock occurrences and for assigning root causes to out-of-stock occurrences are described. In one implementation, inventory data and point of sale data are collected. An expected lost sales value is determined. A true demand is determined based on the point-of-sale data and the expected lost sales value. A probability of an out-of-stock occurrence is determined based on the inventory data. In another implementation, an out-of-stock occurrence is identified. The out-of-stock occurrence is classified, and one or more root causes are assigned to the out-of-stock occurrence.

### CROSS-REFERENCE TO RELATED APPLICATION

This is a patent application which claims the benefit of prior U.S. Provisional Patent Application No. 60/715,778, filed Sep. 9, 2005, the full disclosure of which is incorporated herein by reference.

### TECHNICAL FIELD

This specification relates to inventory management.

### BACKGROUND

Out-of-stock (OOS) conditions are a perennial issue that plagues the retail industry. A direct impact of OOS includes the potential lost sales due to insufficient shelf stock. Thus, reducing a retailer's out-of-stock may lead to an increase in sales.

One key to solving the store-level OOS problem is to improve the store-level inventory visibility and demand visibility. Currently, retailers rely on barcode scanning to track store-level inventory and demand. However, barcode scanning tends to be a labor-intensive process and is not practical for sharing data with manufacturers in real time. Furthermore, lack of real time tracking and data sharing capabilities may make the analysis of out-of-stock situations, including identifying root causes and devising prevention measures, difficult.

### SUMMARY

In some implementations, a computer-implemented method includes: collecting inventory data and point-of-sale (POS) data; determining an expected lost sales value; determining a true demand based on the POS data and the expected lost sales value; and determining a probability of an out-of-stock (OOS) occurrence based on the inventory data.

In some implementations, a system includes one or more processors and one or more sets of instructions configured for execution by the one or more processors. The one or more sets of instructions include instructions to collect inventory data and point-of-sale (POS) data; to determine an expected lost sales value; to determine a true demand based on the POS data and the expected lost sales value; and to determine a probability of an out-of-stock (OOS) occurrence based on the inventory data.

In some implementations, a computer-readable medium has stored thereon instructions, which, when executed by a processor, causes the processor to perform the operations of: collecting inventory data and point-of-sale (POS) data; determining an expected lost sales value; determining a true demand based on the POS data and the expected lost sales value; and determining a probability of an out-of-stock (OOS) occurrence based on the inventory data.

In some implementations, a system includes: means for collecting inventory data and point-of-sale (POS) data; means for determining an expected lost sales value; means for determining a true demand based on the POS data and the expected lost sales value; and means for determining a probability of an out-of-stock (OOS) occurrence based on the inventory data.

In some implementations, a computer-implemented method includes: identifying an out-of-stock (OOS) occurrence; classifying the OOS occurrence; and assigning one or more root causes to the OOS occurrence.

In some implementations, a system includes one or more processors and one or more sets of instructions configured for execution by the one or more processors. The one or more sets of instructions include instructions to identify an out-of-stock (OOS) occurrence, to classify the OOS occurrence, and to assign one or more root causes to the OOS occurrence.

In some implementations, a computer-readable medium has stored thereon instructions, which, when executed by a processor, causes the processor to perform the operations of: identifying an out-of-stock (OOS) occurrence; classifying the OOS occurrence; and assigning one or more root causes to the OOS occurrence.

In some implementations, a system includes means for identifying an out-of-stock (OOS) occurrence, means for classifying the OOS occurrence, and means for assigning one or more root causes to the OOS occurrence.

In some implementations, a computer-implemented method includes: determining a store inventory and a floor inventory over a time period; identifying and classifying one or more OOS occurrences within the time period based on the store inventory and the floor inventory; identifying one or more root cause conditions present during the time period, including applying one or more root cause condition rules; mapping each identified OOS occurrence to at least a subset of the identified root cause conditions; assigning one or more root causes to each identified OOS occurrence based on the mapping; estimating, for each identified OOS occurrence, a respective lost sales value; analyzing the identified OOS occurrences and lost sales values; and identifying one or more OOS prevention actions based on the analyzing.

### BRIEF DESCRIPTION OF THE DRAWINGS

FIG. 1 is a flow diagram illustrating an exemplary process for determining an expected lost sales value and a probability of an OOS occurrence.

FIG. 2 is a flow diagram illustrating an exemplary process for assigning a root cause to an OOS occurrence.

FIG. 3 is a block diagram illustrating a computer system.

FIG. 4 is a diagram illustrating a discrete Kalman filter cycle.

FIG. 5 is a diagram illustrating a Kalman filter operation.

Like reference numbers and designations in the various drawings indicate like elements.

### DETAILED DESCRIPTION

Store inventory data may be collected by using radio frequency identification (RFID) to track the movement or receipt of inventory stock and the movement of inventory stock from a store backroom to the sales floor or shelf. The collected data, along with data collected at the point-of-sale, may be used to determine the probability of an out-of-stock occurring, estimate the lost sales resulting from an out-of-stock situation, identify root causes of an out-of-stock situation, and device out-of-stock prevention measures.

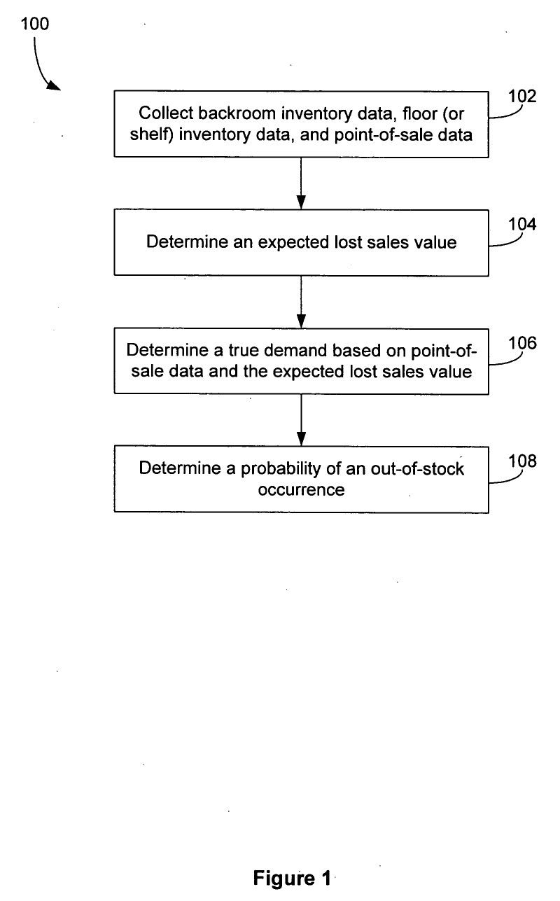

FIG. 1 is a flow diagram illustrating a process flow 100 for determining an expected lost sales value and a probability of an out-of-stock (OOS) occurrence. Inventory data and point-of-sale (POS) data are collected (102). An expected lost sales value is determined (104). A true demand value is determined based on the POS data and the expected lost sales value (106). A probability of an OOS occurrence is determined based on the inventory data (108). The details of the process steps are discussed below.

In some implementations, the inventory data may include snapshot data of the inventory at the warehouse (the supplier), at the store, and/or at the sub-locations of the store (i.e., backroom, sales floor or shelves, etc.). The collection of inventory data may include collection of data regarding the movement of the inventory (for example, how many units of an item were moved from the supplier to the backroom at a time A), as well as the snapshot data. The product movement data and/or the inventory snapshot data may be collected via radio frequency identification (RFID). In some implementations, particular inventory data, such as the store inventory snapshot data, may be derived from data collected via RFID tracking, as described below.

### Store Inventory

The store backroom inventory, also denoted by I_{B} in this specification, may be tracked using radio frequency identification (RFID) store receipt reads and RFID store impact door reads. That is, the backroom inventory data may be collected using RFID readings of goods received from the shipper and goods moved from the backroom to the sales floor or shelf. In some implementations, on a periodic basis, the backroom inventory may be updated according to the following equation:
I_{B}(k)=I_{B}(k−1)+R(k−1)−C(k−1),
where R(k−1) is the store backroom receipt during period (k−1,k), and C(k−1) is the total number of cases moved from backroom to sales floor through impact door during period indices (k−1, k). Both R(k−1) and C(k−1) may be RFID tag read data and may be error-prone. I_{B}(k−1) may be generated manually and may be error-prone. A method of filtering out the error noise is further described below. In some implementations, C, R and I_{B} are in the same unit of measure. In some other implementations, C, R and I_{B} are not in the same unit of measure and suitable scaling constants are used for conversion.

Similarly, the store shelf or floor inventory, also denoted by I_{S} in this specification, may be tracked using RFID store impact door reads and store POS data. That is, the floor inventory data may be collected using RFID reads of goods moving from the backroom to the sales floor or shelf and data collected at the point of sale (e.g., at the checkout or sales counter). In some implementations, the shelf inventory may be updated according to the following equation:
I_{S}(k)=I_{S}(k−1)+C(k−1)−POS(k−1),
where POS(k−1) is the store point-of-sales on period (k−1, k). In some implementations, it is assumed (without loss of generality) that POS(k−1) is accurate. As described above, C(k−1) are RFID tag read data and may be error-prone. I_{S}(k−1) may be generated manually and may be error-prone. A method of filtering out the error noise is further described below. In some implementations, C, POS and I_{S} are in the same unit of measure. In some other implementations, C, POS and I_{S} are not in the same unit of measure and suitable scaling constants are used for conversion.

From the daily store backroom inventory I_{B}(k) and store shelf inventory I_{S}(k), the total store inventory I_{T}(k) may be calculated as I_{T}(k)=I_{B}(k)+I_{S}(k)=I_{T}(k−1)+R(k−1)−POS(k−1).

Based on the backroom inventory data and the floor inventory data, two types of out-of stock may be identified: out-of-stock due to insufficient store inventory (store OOS), and out-of-stock due to inefficient shelf replenishment (floor or shelf OOS).

A store OOS may be determined by observing that I_{T}(k)=0; and a floor OOS may be determined by observing that I_{T}(k)>0 and I_{S}(k)=0. A store OOS is due to insufficient store replenishment, which can be caused by insufficient orders and delayed shipments from the retail warehouse or the supplier. A floor OOS, which is when inventory is available in the backroom but the sales floor or shelves are empty, is mainly due to an inefficient re-shelving or sales floor replenishment schedule.

### Lost Sales

The potential lost sales caused by an out-of-stock occurrence may be estimated in cases where only daily POS data is available and where sub-daily (e.g., hourly, prime time vs. non-prime time) POS data is available, as described below.

Case 1: Only Daily POS Data is Available

In some implementations, it may be assumed that the daily store demand follows, for example, a Poisson distribution with parameter λ. If it is observed that either I_{T}(k+1)=0 or I_{S}(k+1)=0, then there is an OOS for day k. If it is assumed that the sales floor or shelves are replenished once at the beginning of a day (say, midnight) and given the sales data POS(k) for that day, the potential lost sales may be estimated according to the following formula:
Expected Lost Sales during day k

$$\begin{matrix}\begin{matrix}Expected Lost Sales \\ during day k\end{matrix} = E \{ X \text{\textbar} X >= POS ( k ) \} - POS ( k ) \\ = λ * P ( X >= POS ( k ) - 1 ) / \\ P ( X >= POS ( k ) ) - POS ( k ) \\ = \frac{λ \cdot ( 1 - {\sum }_{i = 0}^{POS ( k ) - 2} \frac{{ⅇ}^{- λ} {λ}^{i}}{i !} )}{1 - {\sum }_{i = 0}^{POS ( k ) - 1} \frac{{e}^{- λ} {λ}^{i}}{i !}} - POS ( k )\end{matrix}$$

where X is, for example, a Poisson random variable with parameter λ

Thus, in order to calculate the expected lost sales, a daily sales rate λ is needed. In some implementations, if the daily demand forecast for the store is an unbiased forecast, then daily demand forecast may be used as an approximation for sales rate λ

Case 2: Sub-daily POS Data is Available

In some implementations, it may be the cause that sub-daily POS data, say the prime-time POS data and non-prime-time POS data, are available. From this, the sub-daily store inventory information I_{T}(k) and I_{S}(k) may be determined. During the sub-daily time intervals, the expected lost sales formula described above may be applied to estimate the sub-daily expected lost sales if there is a sub-daily OOS (i.e., store or floor inventory is 0). To estimate the Poisson rate λ during the sub-daily time intervals, the daily store sales forecast may be disaggregated according to the sub-daily store sales pattern. The sub-daily store sales pattern may be obtained by calculating the average percentage of the sub-daily POS data over the daily POS data. Furthermore, the above may be extended to situations where hourly POS data is available.

In some implementations, the POS data may be adjusted with the expected lost sales value to arrive at the “true” demand data according to the following:
Adjusted_{—}POS(k)=POS(k)+Expected Lost Sales during (k−1, k).

The adjustment may be desirable because a future demand forecast based on the unadjusted POS data may underestimate the future demand and thus potentially lead to a low store replenishment quantity, which can cause future OOS and further impact the future POS data.

### Out-of-Stock Prediction

With store inventory data and a daily demand forecast for each item and location with a store replenishment cycle, a prediction of an out-of-stock occurrence may be made. With sub-daily POS data, the prediction may be made on a sub-daily basis. In some implementations, the prediction includes probability of an OOS in a future day and the expected number of lost sales for that future day.

### Store Out-of-Stock Prediction

Suppose that the store replenishment cycle is weekly. The initial store inventory is I_{T}(k) at the beginning of day k, and next seven day forecasts are F(k), . . . , F(k+6). If it is assumed that the daily demand follows, for example, a Poisson distribution with mean F(k+i) for i=0, . . . , 6, then the OOS probability in each day may be estimated according to the following formula:
Probability(Store OOS in

$$\begin{matrix}Probability ( Store OOS in ( k , k + i + 1 ) ) = P ( {X}_{k + i} >= {I}_{T} ( k ) ) \\ = 1 - {\sum }_{j = 0}^{{I}_{T} ( k ) - 1} \frac{{ⅇ}^{- λ ( i )} {λ ( i )}^{j}}{j !}\end{matrix}$$

where Xk+i is, for example, a Poisson distribution with mean λ(i)=F(k+i)+ . . . +F(k+i), for i=0, . . . , 6.

The expected lost sales may be estimated according to the following formula:
Expected Lost Sales ins

$$\begin{matrix}\begin{matrix}Expected Lost Sales \\ in ( k , k + i + 1 )\end{matrix} = E \{ {( {X}_{k + i} - {I}_{T} ( k ) )}^{+} \} \\ = {\sum }_{j = {I}_{T} ( k ) + 1}^{∞} ( j - {I}_{T} ( k ) ) \cdot \frac{{ⅇ}^{- λ ( i )} {λ ( i )}^{j}}{j !} ,\end{matrix}$$

where Xₖ₊ᵢ is, for example, a Poisson distribution with mean λ(i)=F(k)+ . . . +F(k+i), for i=0, . . . , 6.

### Floor Out-of-Stock Prediction

Suppose that the shelf replenishment is done daily. The initial shelf inventory is I_{S}(k) at the beginning of day k, and the next day forecast is F(k). The floor out-of-stock in day k may be estimated according to the following formula:
Pr(Shelf OOS in

$$\begin{matrix}Pr ( Shelf OOS in ( k , k + 1 ) ) = P ( {X}_{k} >= {I}_{S} ( k ) ) \\ = 1 - {\sum }_{j = 0}^{{I}_{S} ( k ) - 1} \frac{{ⅇ}^{- λ} {λ}^{j}}{j !} ,\end{matrix}$$

where Xₖ is, for example, a Poisson distribution with mean λ=F(k).

The expected lost sales may be estimated according to the following formula:
Expected Lost Sales in

$$\begin{matrix}\begin{matrix}Expected Lost Sales \\ in ( k , k + 1 )\end{matrix} = E \{ {( {X}_{k} - {I}_{S} ( k ) )}^{+} \} \\ = {\sum }_{j = {I}_{S} ( k ) + 1}^{∞} ( j - {I}_{S} ( k ) ) \cdot \frac{{e}^{- λ} {λ}^{j}}{j !} ,\end{matrix}$$

where Xₖ is, for example, a Poisson distribution with mean λ=F(k).

### OOS Root Causes

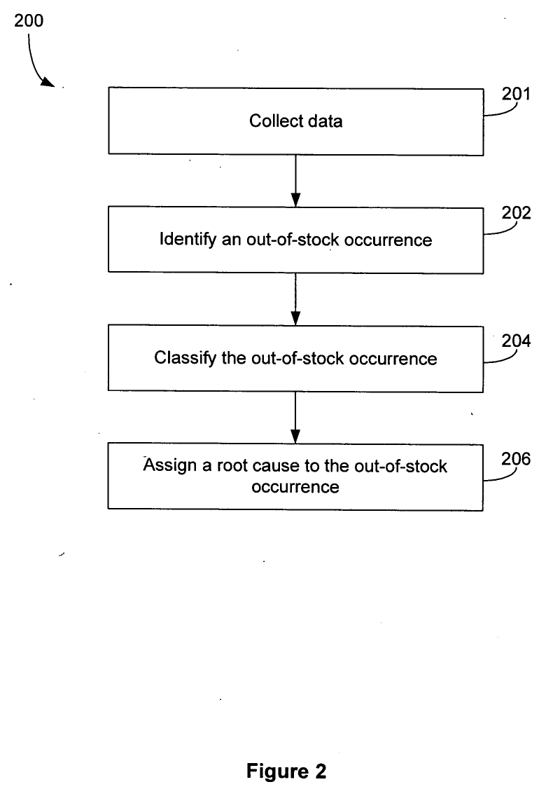

In some implementations, the analysis of OOS occurrences may be taken further to include identification of possible root causes of the OOS occurrences. FIG. 2 is a flow diagram illustrating a process flow 200 for assigning a root cause to an OOS occurrence. Data is collected (201). The data collected may include any combination of the following: warehouse (supplier) inventory data, store inventory data, backroom inventory data, floor (or shelf) inventory data, point-of-sale data, inventory movement data, and forecast and replenishment data (e.g., demand forecasts, the times at which the store inventory and/or sales floor inventory is replenished and the corresponding amounts). Some of these may be derived from data collected via RFID tracking, as described above. An OOS occurrence is identified (202). The OOS occurrence may be identified by monitoring the collected inventory data as described above and determining the store and floor inventory. An OOS occurs when either the store or floor inventory is zero at the end of the day. In some implementations, identification of one or more OOS occurrences may be performed for a specified time period (e.g., 7 days).

The OOS is classified (204). In some implementations, an OOS may be classified as a store or floor OOS. The OOS is a store OOS if the end-of-day store inventory is zero (and the end-of-day floor inventory is zero). If the end-of-day floor inventory is zero but the end-of-day store inventory is not zero, then the OOS is a floor-only OOS (or floor OOS). An OOS may also be classified, separately or together with other classifications (e.g., the store/floor OOS classification described above) as a full or partial OOS. If the POS for the day of an OOS occurrence is positive, the assumption is that the store or floor OOS would have resulted in only partial lost sales, i.e., the OOS occurrence may be classified as a partial OOS. Otherwise, the OOS may be classified as a full OOS. The OOS classification definitions described above are summarized in Table 1 below:

TABLE 1
OOS Definitions

| Is EOD Store | Is EOD Floor | Is the day's | |
|---|---|---|---|
| Inventory Zero? | Inventory Zero? | POS positive? | OOS Type |
| Yes | Yes | No | Store, Full |
| Yes | Yes | Yes | Store, Partial |
| No | Yes | No | Floor (only), |
| | | | Full |
| No | Yes | Yes | Floor (only), |
| | | | Partial |

In some other implementations, other OOS definitions may be used. For example, one alternative is to consider a store-SKU (i.e., an item being sold by the store) to be OOS for a day if the on-hand inventory is less than the next day's forecasted sales.

In some implementations, an OOS % may be calculated as the ratio of the number of OOS days (as determined using the definitions in Table 1) to the total number of days that a product was supposed to be available for sale at a store.

In some implementations, one or more root causes conditions may be identified for the time period in which the OOS occurrences occurred, and the root cause conditions are mapped to particular OOS occurrences in the time period. In some implementations, root cause conditions are identified for the time period by applying a set of rules to the various data that is collected during that time period, as well as other information. An exemplary set of root cause conditions and corresponding rules include:
demand spike: To determine if a demand spike had occurred on a given day for a store-SKU, the actual realized sales are compared against a statistical upper limit for that day's sales;
promotion: To determine whether a store-SKU had an active promotion on a given day;
receipt delay: Receipt delays are found when a shipment receipt arrives beyond a statistical upper limit for that shipment's arrival date;
number of replenishment trips: The number of replenishment trips on a given day for a store-SKU is determined from RFID tracking reads during that day;
new product: To determine whether a product is newly introduced; and
shorted order: Shorted orders are determined when the actual store receipt quantity is less than ordered quantity.

In some implementations, the root cause conditions may be associated with a specified set of root causes. An exemplary set of root causes is described in Table 2 below.

TABLE 2
OOS Root Cause Definitions

| Root Cause | Definition |
|---|---|
| 1. Demand spike | Demand spike preceded the OOS and |
| | there is no promotion going on |
| | for the SKU. |
| 2. Floor replenishment failure | Inventory was not moved to the |
| | selling floor in time to cover the |
| | customer demand requirements for |
| | the day. |
| 3. Insufficient trips | Inventory was not moved frequently |
| | enough from the backroom to the |
| | selling floor to cover the customer |
| | demand requirements for the day. |
| 4. Receipt delay | Product arrived later than expected |
| | to cover customer demand |
| | requirements for the day. |
| 5. Shorted order | Quantity shipped by supplier was |
| | less than the quantity ordered. |
| 6. Promotion demand spike | The OOS occurred while a promotion |
| | was underway and there was a demand |
| | spike. |
| 7. New product cut-in failure | New product inventory was not moved |
| | to the selling floor on time or in |
| | the right quantities to cover customer |
| | demand requirements for the day. |
| 8. Inventory accuracy | None of the above causes and the |
| | inventory quantity in the system |
| | is larger than the store inventory. |
| 9. Othert | Other cause not covered above; with |
| | additional information, this can |
| | be further categorized into, but |
| | not limited to, inaccurate store |
| | forecast, insufficient safety stock, |
| | or some other store replenishment issue. |

If a root cause condition is identified to be present during the time of an OOS occurrence, the root cause condition is mapped to the OOS occurrence. In one implementation, more than one root cause condition may be mapped to an OOS occurrence.

After the classifying, one or more root causes may be assigned to the OOS occurrence (206). Each combination of possible root cause conditions corresponds to an OOS root cause, examples of which are shown in Table 2 above. Below is a non-exhaustive list of combination examples and corresponding root causes:
if there is a floor OOS, no demand spike, and at least one replenishment trip during the day, then the OOS root cause is “Insufficient Trips.” If the product that is out of stock is a new product, then the OOS root cause is “New product cut-in failure;”
if there is a store OOS, no demand spike, and a transit delay, then the OOS root cause is “Receipt delay;”
if there is a store OOS, demand spike, and a promotion, then the OOS root cause is “Promotion demand spike;”
if there is a floor OOS, no demand spike, no replenishment trips during the day, and the product that is out of stock is not a new product, then the OOS root cause is “Floor replenishment failure.”

In some implementations, as the OOS root causes are defined and assigned, as described above, it is possible for an OOS occurrence to have multiple OOS root causes assigned to it. For instance, if there is a store OOS, demand spike, no promotion, and a transit delay, then the OOS root cause is both “Demand Spike” and “Receipt Delay.”

For each OOS occurrence, the lost sales may be estimated. For a day in which the end-of-day store or floor inventory was zero, the lost sales dollar figure is the estimated units beyond what was already sold for that day (as measured by the day's POS) times the retail price. The estimated lost sales units may be estimated as described above by determining the expected lost sales. The expected lost sales may be multiplied by the price to calculate the estimated lost sales dollar value for the OOS. In some implementations, the lost sales may be divided and attributed to different root causes. For example, if the lost sales is $10,000, $7500 may be attributed to receipt delay and $2500 may be attributed to a demand spike.

In some implementations, when an additional OOS occurrence is identified, the OOS classifying and root cause assigning steps (Steps 204-206), including possibly updating the root cause condition identifications and various data, may be performed with respect to the additional OOS occurrence. In one implementation, the updating of the root cause condition identifications and various data may be done incrementally from the last update.

In some implementations, further analysis may be performed on the OOS data, including the assigned root causes and estimated lost sales. One example is to aggregate the OOS days and associated root causes based on certain geographical locations and/or certain time windows to determine whether there are any systematic root causes.

### OOS Prevention

Based on the information determined as described above, including probabilities of OOS occurrences, estimated or expected lost sales, and OOS root causes, measures or actions to prevent or reduce the likelihood of future OOS occurrences may be identified.

In some implementations, OOS prevention measures may be identified based on threshold OOS probabilities or expected lost sales. Identification of OOS prevention measures based on threshold values are described below for two scenarios: when the total inventory can cover for the projected daily demand forecast and when the total inventory cannot cover for the daily demand forecast.

If I_{T}(k) can cover for the projected daily demand forecast during the store replenishment horizon, the optimal shelf or floor capacity needed may be determined based on the daily demand forecast. Assume that the shelf (or floor) replenishment is done on a daily basis. If the target is a floor OOS probability below a specified threshold, say, 1%, then the shelf or floor capacity is determined by finding L such that
Probability(Floor OOS in

$$\begin{matrix}Probability ( Floor OOS in ( k + i , k + i + 1 ) ) = P ( {X}_{k + i} >= L ) \\ = 1 - {\sum }_{j = 0}^{L - 1} \frac{{ⅇ}^{- λ} {λ}^{j}}{j !} \\ < 1 \% ,\end{matrix}$$

where Xk+i is, for example, a Poisson distribution with mean λ=F(k+i).

Or, if the target is an expected lost sales below a specified threshold, say β units, then the shelf or floor capacity is determined by find L such that
Expected Lost Sales in

$$\begin{matrix}\begin{matrix}Expected Lost Sales \\ in ( k + i , k + i + 1 )\end{matrix} = E \{ {( {X}_{k + i} - L )}^{+} \} \\ = {\sum }_{j = L + 1}^{∞} ( j - L ) \cdot \frac{{ⅇ}^{- λ} {λ}^{j}}{j !} \\ < β ,\end{matrix}$$

where Xₖ₊ᵢ is, for example, a Poisson distribution with mean λ=F(k+i).

If the shelf or floor capacity cannot be changed, the optimal trips required for shelf or floor replenishment may be determined based on the daily demand forecast and the shelf or floor capacity. If the goal is a floor OOS probability below a specified threshold, say, 1%, then the number of trips needed is determined by finding T such that
Probability(Shelf OOS in

$$\begin{matrix}Probability ( Shelf OOS in ( k + i , k + i + 1 ) ) = P ( {X}_{k + i} >= T * L ) \\ = 1 - {\sum }_{j = 0}^{TL - 1} \frac{{ⅇ}^{- λ} {λ}^{j}}{j !} \\ < 1 \% ,\end{matrix}$$

where Xₖ₊ᵢ is, for example, a Poisson distribution with mean λ=F(k+i).

Or, if the target is an expected lost sales below a specified threshold, say β units, then the number of trips needed is determined by find T such that
Expected Lost Sales in

$$\begin{matrix}\begin{matrix}Expected Lost Sales \\ in ( k + i , k + i + 1 )\end{matrix} = E \{ {( {X}_{k + i} - T * L )}^{+} \} \\ = {\sum }_{j = TL + 1}^{∞} ( j - TL ) \cdot \frac{{ⅇ}^{- λ} {λ}^{j}}{j !} \\ < β ,\end{matrix}$$

where Xk+i is, for example, a Poisson distribution with mean λ=F(k+i).

If I_{T}(k) cannot cover for the projected daily demand forecast during the store replenishment horizon, the time when the store needs to be replenished may be determined based on the predicted OOS probability or the expected lost sales. If the target is an OOS probability below a specified threshold, say, 2%, then the next replenishment time is determined as t+i whenever
Probability(Store OOS in

$$\begin{matrix}Probability ( Store OOS in ( k , k + i + 1 ) ) = P ( {X}_{k + i} >= {I}_{T} ( k ) ) \\ = 1 - {\sum }_{j = 0}^{{I}_{T} ( k ) - 1} \frac{{ⅇ}^{- λ ( i )} {λ ( i )}^{j}}{j !} \\ > 2 \% ,\end{matrix}$$

where Xₖ₊ᵢ is, for example, a Poisson distribution with mean λ(i)=F(k)+ . . . +F(k+i), for i=0, . . . , 6. The replenishment quantity may be determined based on the future sales forecast and the store safety stock.

Similarly, if the target is an expected lost sales below a specified threshold, say β units, then the next replenishment time is determined as t+i whenever
Expected Los Sales in

$$( k , k + i + 1 ) = E \{ {( {X}_{k + i} - {I}_{T} ( k ) )}^{+} \} = {\sum }_{j = {I}_{T} ( k ) + 1}^{∞} ( j - {I}_{T} ( k ) ) \cdot \frac{{ⅇ}^{- λ ( ⅈ )} {λ ( i )}^{j}}{j !} > β ,$$

where Xₖ₊ᵢ is, for example, a Poisson distribution with mean λ(i)=F(k)+ . . . +F(k+i), for i=0, . . . , 6. The replenishment quantity may be determined based on the future sales forecast and store safety stock.

In some implementations, the root causes may be included in the analysis and prevention measures or actions targeted toward particular root causes may be identified.

It should be appreciated that while the description above uses the Poisson probability distribution as the probability model for the daily demand, other probability distributions may be used to model the daily demand.

### Estimation of Store-Level Inventory under Erroneous RFID data

As described above, the RFID tracking may have erroneous data. A Kalman filter may be employed to compensate for the errors in the RFID data, as described below.

In some implementations, the Kalman filter approach to compensate for the errors in the RFID data includes one or more assumptions:
1. Store backroom, store shelf inventory, and/or store total inventory (two out of these three) is measured at the same frequency as the desired estimation frequency. If not, a modified, more complex, Kalman filter extended to the case of intermittent observations may be used.
2. Inventory and RFID reads are available at the same frequency. If RFID reads are available more frequently, a simple reformulation would be needed to the following formulation.
3. Error in the measurements (RFID, store-level inventory measurement) follows normal distribution.
4. Enough history of measurements is available to train the Kalman filter as well as calculate the measurement noise covariance. State noise covariance may be estimated from data or determined by simulation.
   State-Space Model of Inventory Evolution:

The state of the system may be defined as the vector:

$${x}_{k} = [ \begin{matrix}{I}_{B} ( k ) \\ {I}_{S} ( k )\end{matrix} ] .$$

The RFID tracking data and POS data may be modeled as control inputs to the system by defining the control input vector as:

$${u}_{k - 1} = [ \begin{matrix}R ( k - 1 ) \\ C ( k - 1 ) \\ POS ( k - 1 )\end{matrix} ] .$$

Assuming that the error in the RFID tracking data R is normally distributed, the RFID read may be modeled as being composed of two parts: a mean and a normally distributed error around this mean. The mean value is what is read from the RFID tags but the actual value that affects the system inventory includes some error. The store inventory reads I_{B} and I_{S} may be modeled as being composed of two parts: a mean and a normally distributed error around this mean. The mean value is what is generated by the store-level inventory reads but the actual value that affects the system includes the error.

Under this decomposition model, the inventory equations above can be rewritten as the state-space model:

$${x}_{k} = {Ax}_{k - 1} + {Bu}_{k - 1} + {ω}_{k - 1} , \\ with$$

$$A = [ \begin{matrix}1 & 0 \\ 0 & 1\end{matrix} ]$$

$$B = [ \begin{matrix}1 & - 1 & 0 \\ 0 & 1 & - 1\end{matrix} ] , \\ and$$

$${ω}_{k - 1} = [ \begin{matrix}{ω}_{k - 1}^{B} \\ {ω}_{k - 1}^{S}\end{matrix} ]$$

$$with$$

$$p ( {ω}_{k - 1} ) ∼ N ( 0 , Q ) .$$

Assuming that periodic inventory measurements of both states are available, the 10 observation equation is:
Zₖ=Xₖ+υₖ with p(υₖ)˜N(0,R)
where υₖ is the measurement noise and is characterized by the covariance matrix R.

The determination of the process noise covariance Q is generally more difficult as it may not be possible to directly observe the process to be estimated. Sometimes a relatively 15 simple process model can produce acceptable results if one “injects” enough uncertainty into the process via the selection of Q. Certainly in this case one would hope that the process measurements are reliable. In either case, whether or not there is a rational basis for choosing the parameters, often times superior filter performance (statistically speaking) can be obtained by tuning the filter parameters Q and R. The tuning can be performed off-line, frequently with the help of another (distinct) Kalman filter in a process generally referred to as system identification.

Kalman Filter Model for Inventory Estimation

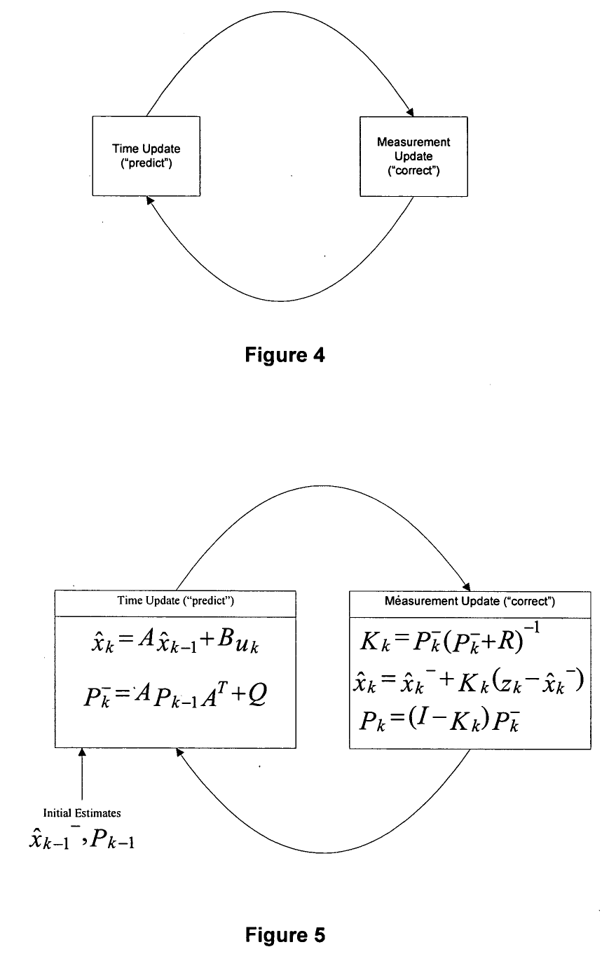

The Kalman filter estimates the inventory by using a form of feedback control: the filter estimates the inventory at some time and then obtains feedback in the form of (noisy) inventory measurements. As such, the equations for the Kahnan filter fall into two groups: time update equations and measurement update equations. The time update equations are responsible for projecting forward (in time) the current inventory and error covariance estimates to obtain the a priori inventory estimate for the next time step. The inventory measurement update equations are responsible for the feedback—i.e. for incorporating a new inventory measurement into the a priori inventory estimate to obtain an improved a posteriori inventory estimate. The time update inventory equations can also be thought of as predictor equations, while the inventory measurement update equations can be thought of as corrector equations. Indeed the final estimation algorithm resembles that of a generic predictor-corrector algorithm for solving numerical problems as shown in FIG. 4.

The specific equations for time update are as follows:
\hat{X}ₖ=A\hat{X}ₖ₋₁+Bᵤₖ
Pₖ⁻=APₖ₋₁A^{T}+Q
which project the inventory and covariance estimates forward in time from k−1 to k.

The specific equations for measurement update are as follows:
Kₖ=Pₖ⁻(Pₖ⁻+R)⁻¹,
\hat{X}ₖ=\hat{X}ₖ⁻+Kₖ(Zₖ−\hat{X}ₖ⁻) and
Pₖ=(I−Kₖ)Pₖ⁻

Combining FIG. 4 with the above set of equations results in a Kalman filter operation as illustrated in FIG. 5.

Conditional Probability Estimates for Inventory Based on History of Observations

A conditional probability of the system inventory given the history of observations of the inventory may be determined. Under the assumptions described above, it is known from Kalman filtering theory that
P(Xₖ|Zₖ)˜N(\hat{X}ₖ, Pₖ),
where Pₖ is the a posteriori estimate error covariance and is provided by the equation described above. Thus, through the recursive application of the Kalman filter equations, at time k, the conditional probability of the inventory in the system given the history of observations may be calculated.

For example, consider the case where only one variable, say store shelf inventory, is being estimated. The actual probability of the floor or shelf inventory being above a required safety stock level may be calculated as
P(I_{S}^{(k)}≧I_{SS}|Zₖ)
through the standard normal density function tables. If the calculated probability is below a desired number α, a recommended control action like replenishment to move a certain quantity of goods from the backroom to the sales floor or shelves may be performed. The replenishment quantity may be calculated from the normal distribution tables. Assume that this recommendation is acted upon in the next period. The Kalman filter equations will have a new control action C(k+1) along with new inventory observation z(k+1) to estimate
P(I_{S}^{(k+1)}≧I_{SS}|Zₖ₊₁)

If the recommendation was followed through, one could expect that
P(I_{S}^{(k+1)}≧I_{SS}|Zₖ₊₁)^{24 α.}

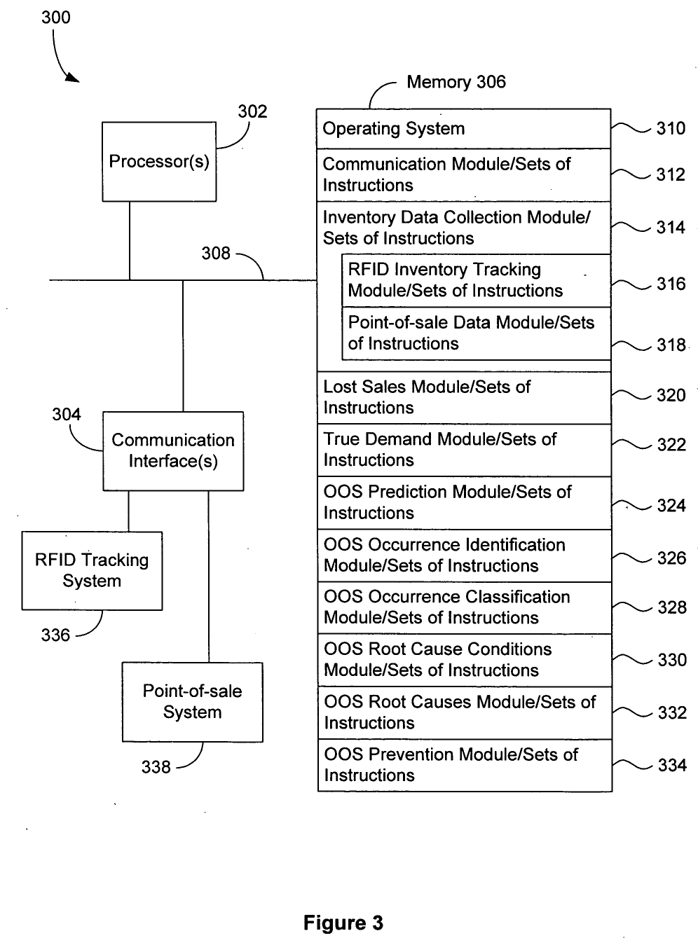

FIG. 3 is a block diagram illustrating a computer system 300 for predicting OOS occurrences and assigning root causes. The computer system 300 includes one or more processors 302, one or more communication interfaces 304 for interfacing with other computers or devices, memory 306, and a data bus 308 for interconnecting these components. The computer system 300 may also include a user interface (not shown), which may include output device such as a display and input devices such as a keyboard and/or a mouse. Memory 306 may include volatile memory such as DRAM, SRAM, DDR RAM, etc., as well as non-volatile memory such as magnetic hard disk drives, flash memory, optical disks, magnetic tape, etc. Memory 306 may also include volatile or non-volatile memory that is located remotely from the processor(s) 302 (e.g., network-attached storage).

Memory 306 may store the following modules, sets of instructions, data, or subsets or supersets thereof:
an operating system 310 for performing system operations;
a communication module or sets of instructions 312 for communicating, through the communication interface 304, with other computers or devices through a local area network, wide area network, the Internet, and so forth;
an inventory data collection module 314 for collecting inventory and point-of-sale data;
a lost sales module/sets of instructions 320 for determining expected lost sales values;
a true demand module/sets of instructions 322 for determining “true” demand values;
an OOS prediction module/sets of instructions 324 for determining probabilities of OOS occurrences;
an OOS occurrence identification module/sets of instructions 326 for identifying OOS occurrences;
an OOS occurrence classification module/sets of instructions 328 for classifying OOS occurrences;
an OOS root cause conditions module/sets of instructions 330 for identifying OOS root cause conditions;
an OOS root causes module/sets of instructions 332 for assigning root causes to OOS occurrences; and
an OOS prevention module/sets of instructions 334 for identifying OOS prevention measures or actions.

The inventory data collection module 314 includes an RFID tracking module/sets of instruction 316 for collecting inventory tracking data via an RFID tracking system, and a point-of-sale data module/sets of instructions 318 f6r collecting point-of-sale data via a point-of-sale system.

The communications interface(s) 304 may be coupled by wire or wireless communication to an RFID tracking system 336 for tracking inventory and a point-of-sale system 338 for collecting point-of-sale data. The RFID tracking system tracks inventory (for example, via one or more RFID readers) and transmits the tracking data to the computer system 300 for further processing. In some implementations, the RFID tracking system includes one or more computers and one or more RFID readers. The point-of-sale (POS) system collects data at the point of sale (e.g., purchased items, returned items) and transmits the data to the computer system 300 for further processing.

It should be appreciated that memory 306 may also store additional modules, sets of instructions, or data in addition to those listed above. Modules or components shown separately may be combined and modules or components shown together may be separated.

The disclosed and other embodiments and the functional operations described in this specification can be implemented in digital electronic circuitry, or in computer software, firmware, or hardware, including the structures disclosed in this specification and their structural equivalents, or in combinations of one or more of them. The disclosed and other embodiments can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system.

A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the disclosed embodiments can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well;

for example, feedback provided to the user can be any form of sensory feedback, e.g., visual feedback, auditory feedback, or tactile feedback; and input from the user can be received in any form, including acoustic, speech, or tactile input.

The disclosed embodiments can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of what is disclosed here, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of what being claims or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments have been described. Other embodiments are within the scope of the following claims.

What is claimed is:

1. A computer-implemented method, comprising:
collecting inventory data and point-of-sale (POS) data;
determining an expected lost sales value;
determining a true demand based on the POS data and the expected lost sales value; and
determining a probability of an out-of-stock (OOS) occurrence based on the inventory data.

2. The method of claim 1, further comprising:
identifying an OOS prevention measure, thereby reducing one of the probability of the OOS occurrence or the expected lost sales value to less a respective specified threshold.

3. The method of claim 1, wherein collecting inventory data comprises collecting inventory movement data.

4. The method of claim 3, wherein collecting inventory movement data comprises tracking inventory movement using radio frequency identification (RFID).

5. The method of claim 1, wherein determining the probability of an OOS occurrence comprises determining at least one of a probability of a store OOS occurrence or a probability of a floor OOS occurrence.

6. The method of claim 1, wherein identifying an OOS prevention measure comprises determining an optimal floor capacity.

7. The method of claim 1, wherein identifying an OOS prevention measure comprises determining an optimal number of floor replenishment trips.

8. The method of claim 1, wherein identifying an OOS, prevention measure comprises determining a store replenishment time.

9. A system, comprising:
one or more processors;
one or more sets of instructions configured for execution by the one or more processors; the one or more sets of instructions comprising instructions:
to collect inventory data and point-of-sale (POS) data;
to determine an expected lost sales value;
to determine a true demand based on the POS data and the expected lost sales value; and
to determine a probability of an out-of-stock (OOS) occurrence based on the inventory data.

10. A computer-readable medium having stored thereon instructions, which, when executed by a processor, causes the processor to perform the operations of:
collecting inventory data and point-of-sale (POS) data;
determining an expected lost sales value;
determining a true demand based on the POS data and the expected lost sales value; and
determining a probability of an out-of-stock (OOS) occurrence based on the inventory data.

11. A system, comprising:
means for collecting inventory data and point-of-sale (POS) data;
means for determining an expected lost sales value;
means for determining a true demand based on the POS data and the expected lost sales value; and
means for determining a probability of an out-of-stock (OOS) occurrence based on the inventory data.

12. A computer-implemented method, comprising:
identifying an out-of-stock (OOS) occurrence;
classifying the OOS occurrence; and
assigning one or more root causes to the OOS occurrence.

13. The method of claim 12, further comprising:
collecting data.

14. The method of claim 13, wherein collecting data comprises collecting at least one of the group consisting of: warehouse inventory data, store inventory data, backroom inventory data, floor inventory data, point-of-sale data, inventory movement data, and forecast and replenishment data.

15. The method of claim 12, wherein classifying the OOS occurrence comprises:
classifying the OOS occurrence as a store OOS if a store inventory is zero and a floor inventory is zero; and
classifying the OOS occurrence as a floor OOS if the store inventory is not zero and the floor inventory is zero.

16. The method of claim 12, wherein classifying the OOS occurrence comprises:
identifying one or more root cause conditions; and
mapping at least a subset of the root cause conditions to the OOS occurrence.

17. The method of claim 12, further comprising:
determining a lost sales value for the OOS occurrence;
analyzing the OOS occurrence and the lost sales value; and
identifying one or more OOS prevention actions based on the analyzing.

18. The method of claim 12, further comprising:
upon identification of an additional OOS occurrence, performing the classifying and the assigning steps with respect to the additional OOS occurrence.

19. A system, comprising:
one or more processors;
one or more sets of instructions configured for execution by the one or more processors; the one or more sets of instructions comprising instructions:
to identify an out-of-stock (OOS) occurrence;
to classify the OOS occurrence; and
to assign one or more root causes to the OOS occurrence.

20. A computer-readable medium having stored thereon instructions, which, when executed by a processor, causes the processor to perform the operations of:
identifying an out-of-stock (OOS) occurrence;
classifying the OOS occurrence; and
assigning one or more root causes to the OOS occurrence.

21. A system, comprising:
means for identifying an out-of-stock (OOS) occurrence;
means for classifying the OOS occurrence; and
means for assigning one or more root causes to the OOS occurrence.

22. A computer-implemented method, comprising:
determining a store inventory and a floor inventory over a time period;
identifying and classifying one or more OOS occurrences within the time period based on the store inventory and the floor inventory;
identifying one or more root cause conditions present during the time period, including applying one or more root cause condition rules;
mapping each identified OOS occurrence to at least a subset of the identified root cause conditions;
assigning one or more root causes to each identified OOS occurrence based on the mapping;
estimating, for each identified OOS occurrence, a respective lost sales value;
analyzing the identified OOS occurrences and lost sales values; and
identifying one or more OOS prevention actions based on the analyzing.
